(19) United States
(12) Patent Application Publication
(10) Pub. No.: US 2010/0223465 A1
(43) Pub. Date: Sep. 2, 2010

(54) METHOD FOR LENDING OUT ELECTRONIC KEY AND COMMUNICATION TERMINAL

(75) Inventor: Takefumi Matsui, Kanagawa (JP)

Correspondence Address: PEARNE & GORDON LLP, 1801 EAST 9TH STREET, SUITE 1200, CLEVELAND, OH, 44114-3108, US

(73) Assignee: PANASONIC CORPORATION, Osaka (JP)

(21) Appl. No.: 12/377,342

(22) PCT Filed: Dec. 20, 2006
(86) PCT No.: PCT/JP2006/325422

§ 371 Date: Feb. 12, 2009

(51) Int. Cl. H04L 9/32; G06F 15/16; H04L 9/08

(52) U.S. Cl. 713/168; 709/227; 380/283

(57) ABSTRACT

The present invention aims at providing an electronic key lending method capable of ensuring the high security by a relatively easy method. An electronic key lending method of the present invention of lending an electronic key (7) that unlocks or locks an electronic lock (8) from a first communication terminal (10-1), includes an electronic key transmitting step of transmitting the electronic key (7) from the first communication terminal (10-1) to a second communication terminal (10-2) while an IMS session is established between the first communication terminal (10-1) and the second communication terminal (10-2).

### TECHNICAL FIELD

The present invention relates to a method for lending out an electronic key of enabling communication terminals to lend mutually an electronic key produced by software such as program, data, or the like, and a communication terminal equipped with a function of lending the electronic key.

### BACKGROUND ART

In recent years the electronic locks utilizing the above electronic key are taking the place of physical locks. Mainly the electronic key is stored in the communication terminal such as the cellular phone, or the like, the IC card, and others and used. In many cases the electronic key (key information) is stored in the memory medium such as the IC card, or the like before such memory medium is issued, and such memory medium is used in the access management system, for example. Also, the electronic key can be distributed to the communication terminal such as the cellular phone, or the like. It has been proposed that the electronic key can be distributed from the system or the server that manages the electronic keys (see Patent Literature 1, for example). Also, it has been proposed that the system or the server does not manage the electronic keys and the communication terminals directly lend out the electronic key mutually (see Patent Literature 2, for example).

### Patent Literature 1: JP-A-2006-144264

### Patent Literature 2: JP-A-2006-79402

### DISCLOSURE OF THE INVENTION

### Problems that the Invention is to Solve

However, there is a problem that a complicated system is needed to implement the electronic key set forth in Patent Literature 1. Also, the concrete implementing method is not fully discussed in Patent Literature 2. In addition, there is a problem that the electronic keys set forth in Patent Literature 1 and Patent Literature 2 cannot ensure the high security.

The present invention has been made in view of such circumstances, and it is an object of the present invention to provide a method of lending out an electronic key capable of ensuring the high security by a relatively easy method, and a communication terminal applicable to the electronic key lending method.

### Means for Solving the Problems

In order to solve the above problem, a method of lending out an electronic key which unlocks or locks an electronic lock from a first communication terminal, according to an embodiment of the present invention, including:

an electronic key transmitting step of transmitting the electronic key from the first communication terminal to a second communication terminal while an IMS session is established between the first communication terminal and the second communication terminal.

According to this method, the electronic key is transmitted from the first communication terminal to the second communication terminal through the IMS while the IMS session is established between the first communication terminal and the second communication terminal. Therefore, the high security in using the electronic key can be ensured by a relatively easy method.

Also, preferably, the electronic key transmitting step is executed while the first communication terminal and the second communication terminal hold communication. In this case, since the first communication terminal is communicating with the second communication terminal, the first communication terminal can transmit the electronic key to the second communication terminal while checking a situation of the opposing terminal (the second communication terminal). Therefore, the higher security in using the electronic key can be ensured. In particular, if the electronic key transmitting step is performed through the phone conversation or the TV phone that the first communication terminal and the second communication terminal hold, the first communication terminal can check easily a user's authenticity of the opposing terminal (the second communication terminal). As a result, this mode is very preferable.

Also, the electronic key may be transmitted selectively from the first terminal to the second terminal in the electronic key transmitting step when the first communication terminal receives a first signal. In this case, the unnecessary lending of the electronic key can be suppressed and the lending of the electronic key can be carried out effectively.

Also, the electronic key lending method may further include an electronic key enabling step of opening or shutting the electronic lock selectively by the electronic key when the electronic lock receives a second signal after the electronic key transmitting step. In this case, the higher security in using the electronic key can be ensured.

Also, the electronic key lending method may further include an electronic key disabling step of disabling the electronic key when the second communication terminal receives a third signal after the electronic key transmitting step. In this case, the higher security in using the electronic key can be ensured.

In order to solve the above problem, a communication terminal according to an embodiment of the present invention includes an IMS session establishing section for establishing an IMS session between an own communication terminal and other communication terminal; and an electronic key transmitting section which transmits an electronic key to the other communication terminal to open or shut an electronic lock while the IMS session is established.

According to this communication terminal, the electronic key is transmitted from the first communication terminal to the second communication terminal through the IMS while the IMS session is established between the first communication terminal and the second communication terminal. Therefore, the high security in using the electronic key can be ensured by a relatively easy method.

Also, preferably, the electronic key transmitting section transmits the electronic key while the own communication terminal is communicating with other communication terminal. In this case, since the own communication terminal is communicating with the other communication terminal, the own communication terminal can transmit the electronic key to the other communication terminal while checking a situation of the opposing terminal. Therefore, the higher security in using the electronic key can be ensured.

Also, the electronic key transmitting section may transmit the electronic key selectively when the own communication terminal receives a predetermined signal from other communication terminal. In this case, the unnecessary lending of the electronic key can be suppressed and the lending of the electronic key can be carried out effectively.

Also, the communication terminal may further include an electronic key enabling signal transmitting section which transmits an electronic key enabling signal to open or shut the electronic lock by the electronic key. In this case, the higher security in using the electronic key can be ensured.

Also, the communication terminal may further include an electronic key disabling signal transmitting section which transmits an electronic key disabling signal to disable the electronic key. In this case, the higher security in using the electronic key can be ensured.

In order to solve the above problem, a communication terminal according to an embodiment of the present invention includes an IMS session establishing section which establishes an IMS session between an own communication terminal and other communication terminal; and an electronic key receiving section which receives an electronic key to the other communication terminal to open or shut an electronic lock while the IMS session is established.

According to this communication terminal, the electronic key is transmitted from the own communication terminal to the other communication terminal through the IMS while the IMS session is established between the own communication terminal and the other communication terminal. Therefore, the high security in using the electronic key can be ensured by a relatively easy method.

Also, preferably, the electronic key receiving section receives the electronic key while the own communication terminal is communicating with other communication terminal. In this case, since the own communication terminal is communicating with the other communication terminal, the own communication terminal can transmit the electronic key to the other communication terminal while checking a situation of the opposing terminal. Therefore, the higher security in using the electronic key can be ensured.

Also, the communication terminal may further include an electronic key request signal transmitting section which transmits a signal indicating an electronic key lending request to the other communication terminal. In this case, the unnecessary lending of the electronic key can be suppressed and the lending of the electronic key can be carried out effectively.

Also, the communication terminal may further include an electronic key enabling signal receiving section which receives an electronic key enabling signal to open or shut the electronic lock by the electronic key. In this case, the higher security in using the electronic key can be ensured.

Also, the communication terminal may further include an electronic key disabling signal receiving section which receives an electronic key disabling signal to disable the electronic key. In this case, the higher security in using the electronic key can be ensured.

### ADVANTAGE OF THE INVENTION

The electronic key lending method and the communication terminal of the present invention employ the IMS, and therefore can ensure the high security in using the electronic key by the relatively easy method.

### BRIEF DESCRIPTION OF THE DRAWINGS

FIG. 1 is a block diagram showing a pertinent configuration of a communication terminal according to an embodiment 1 of the present invention;

FIG. 2 is a block diagram showing a pertinent configuration of another communication terminal according to the embodiment 1 of the present invention;

FIG. 3 is a conceptual view explaining an electronic key lending method according to the embodiment 1 of the present invention;

FIG. 4 is a view explaining an electronic key 7;

FIG. 5 is a sequence chart showing a process of the communication terminal in lending the key according to the embodiment 1 of the present invention;

FIG. 6 is a block diagram showing a pertinent configuration of a communication terminal according to an embodiment 2 of the present invention;

FIG. 7 is a block diagram showing a pertinent configuration of another communication terminal according to the embodiment 2 of the present invention;

FIG. 8 is a sequence chart showing a process of the communication terminal taken in lending the key according to the embodiment 2 of the present invention;

FIG. 9 is a block diagram showing a pertinent configuration of a communication terminal according to an embodiment 3 of the present invention;

FIG. 10 is a block diagram showing a pertinent configuration of another communication terminal according to the embodiment 3 of the present invention;

FIG. 11 is a sequence chart showing a process of the communication terminal taken in lending the key according to the embodiment 3 of the present invention;

FIG. 12 is a block diagram showing a pertinent configuration of a communication terminal according to an embodiment 4 of the present invention;

FIG. 13 is a block diagram showing a pertinent configuration of another communication terminal according to the embodiment 4 of the present invention;

FIG. 14 is a sequence chart showing a process of the communication terminal taken in lending the key according to the embodiment 4 of the present invention;

FIG. 15 is a block diagram showing a pertinent configuration of a communication terminal according to an embodiment 5 of the present invention;

FIG. 16 is a block diagram showing a pertinent configuration of another communication terminal according to the embodiment 5 of the present invention; and

FIG. 17 is a sequence chart showing a process of the communication terminal taken in lending the key according to the embodiment 5 of the present invention.

### DESCRIPTION OF REFERENCE NUMERALS

7 electronic key
8 electronic lock
9 IMS network
10-1, 10-2, 50-1, 50-2, 60-1, 60-2, 70-1, 70-2, 80-1, 80-2 communication terminal
11 antenna
12 transmitting/receiving portion
13 sound/video talk processing portion
14 microphone
15 speaker
16 display
1 camera
18 key operating portion
19, 19A controlling portion
20 session establishing portion
21 electronic key transmitting portion
21-2 electronic key receiving portion
22 disable command transmitting portion
22-2 disable command receiving portion
23 electronic key storing portion
51 key lending petition receiving portion
51-2 key lending petition transmitting portion
61 electronic key return receiving portion
61-2 electronic key return transmitting portion
71 key disable information receiving portion
71-2 key disable information transmitting portion
81 onetime password request receiving portion
81-2 onetime password request transmitting portion
82 onetime password transmitting portion
82-2 onetime password receiving portion

### BEST MODE FOR CARRYING OUT THE INVENTION

An electronic key lending method of the present invention provides an electronic key lending method of lending an electronic key that unlocks or locks an electronic lock from a first communication terminal. The electronic key lending method of the present invention has an electronic key transmitting step of transmitting the electronic key from the first communication terminal to a second communication terminal while an IMS session is established between the first communication terminal and the second communication terminal.

The electronic key lending method of the present invention utilizes an IMS (IP Multimedia Subsystem) whose standardization is proceeding in 3GPP (3rd Generation Partnership Project: standardization project of the third generation mobile telecommunications system). In the IMS, various exchanges of data between TV phones or communication terminals as well as the IP phone conversation can be carried out through SIP (Session Initiation Protocol) as the protocol used in the Internet phone, or the like. This SIP is the third noticeable protocol of the Internet following SMTP (Simple Mail Transfer Protocol) and HTTP (Hyper Text Transfer Protocol) that IETF (Internet Engineer Task Force) serving as the standardization group of the Internet makes progress in their standardization.

In case the electronic key is lent by using the phone conversation or the TV phone in the prior art, such a problem existed that such electronic key lending cannot be easily realized because a new communication protocol or a new communication system must be built up. In contrast, the electronic key lending method of the present invention does not demand a particular change on the network side because the IMS is utilized in such method. Thus, the electronic key lending method can be implemented by a relatively easy method. Also, the electronic key can be transmitted through the IMS session that is established to have the conversation between the communication terminals. Therefore, it is not needed that the communication system should be set up separately to transmit the electronic key.

Also, because the user can utilize the user authentication of IMS, the lending the electronic key can be carried out with ensuring the high security. The user authentication of IMS is explained in Gonzalo Camarillo, Miguel A. Garc'ia Mart'in: “Detailed Introduction Network IMS (IP Multimedia Subsystem) Standard Text NGN Core Technology”, First Version, Ric Telecom Inc., Jul. 16, 2006, p. 48-56, for example.

In the electronic key lending method of embodiments of the present invention, preferably, the electronic key transmitting step should be executed while the first communication terminal and the second communication terminal are holding communication (through the phone conversation or on the TV phone). If the first communication terminal lends the second communication terminal the electronic key while the first communication terminal is communicating with the second communication terminal (through the phone conversation or the TV phone), the user of the first communication terminal can talk with the user of the second communication terminal to check a situation of the user of the second communication terminal and then can lend the electronic key. Therefore, the electronic key can be lent out in higher security.

Here, the session is the logical connection in communication being carried out between the communicable systems, and the IMS session is the session using the IMS. The communicable systems contain the first communication terminal and the second communication terminal, for example. The establishing of the session means that the session is established and is in a connectable state. In contrast, the opening of the session means that the session is cut and is in a non-connectable state.

The electronic key and the electronic lock are used in pairs. If the electronic key is used in the predetermined method, the electronic lock can be unlocked and/or locked.

Next, preferred embodiments for carrying out the present invention will be explained in more detail with reference to the drawings hereinafter.

### Embodiment 1

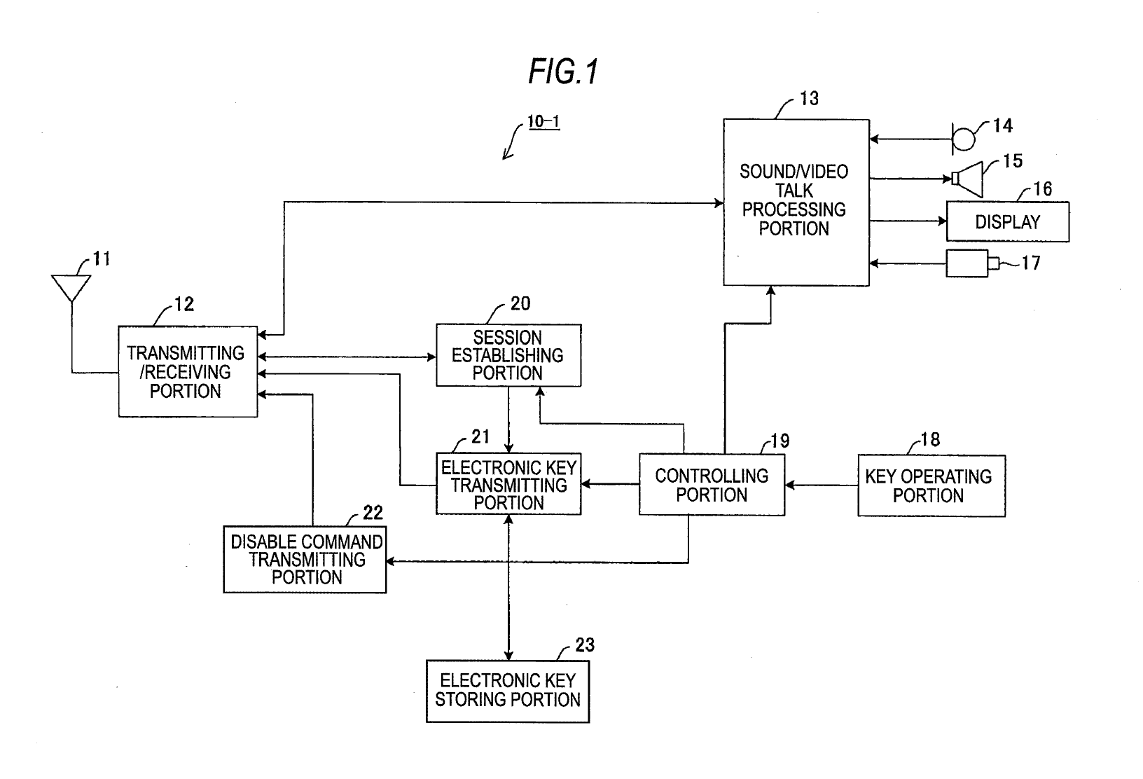

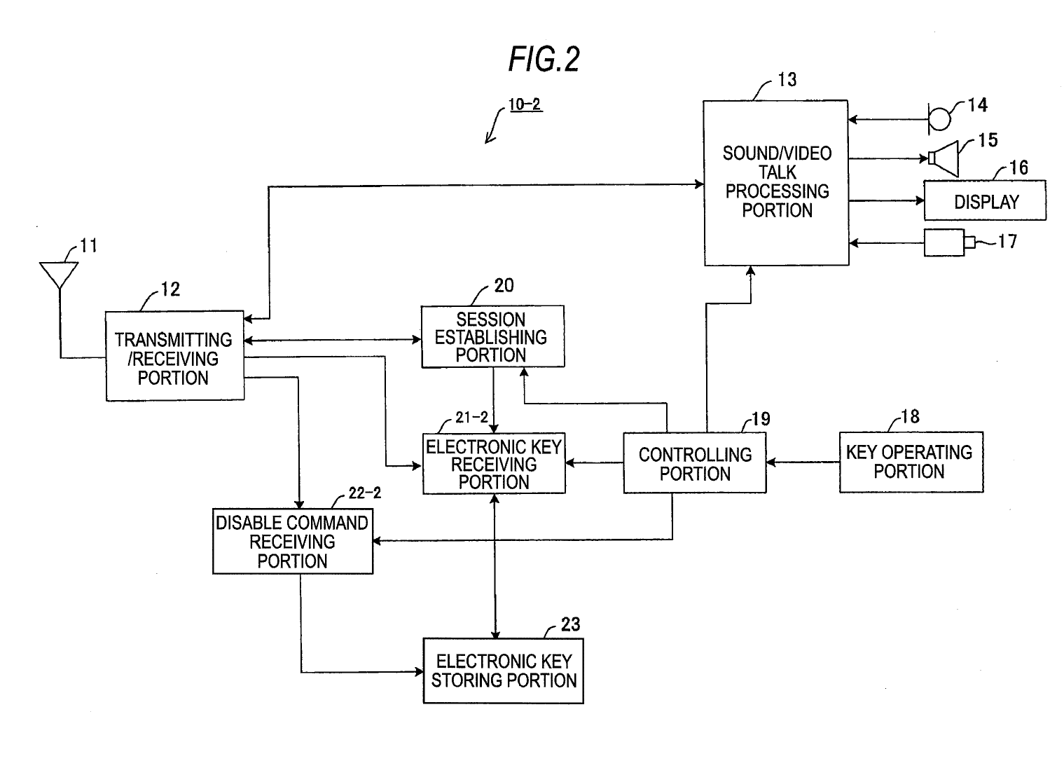

FIG. 1 is a block diagram showing a pertinent configuration of a communication terminal 10-1 (a communication terminal on the side which lends an electronic key) used in an electronic key lending method of an embodiment 1 of the present invention. FIG. 2 is a block diagram showing a pertinent configuration of another communication terminal 10-2 (a communication terminal on the side to which the electronic key is lent) used in the electronic key lending method of the embodiment 1 of the present invention. Now, communication terminals (cellular phones herein) 10-1, 10-2 of the present embodiment have a function that is adaptable to the IMS respectively.

As shown in FIG. 1, the communication terminal 10-1 is equipped with an antenna 11, a transmitting/receiving portion 12, a sound/video talk processing portion 13, a microphone 14, a speaker 15, a display 16, a camera 17, a key operating portion 18, a controlling portion 19, a session establishing (an IMS session establishing section) portion 20, an electronic key transmitting portion (an electronic key transmitting section) 21, a disable command transmitting portion (an electronic key disabling signal transmitting section) 22, and an electronic key storing portion 23. The antenna 11 is used to transmit/receive a radio frequency signal used by the cellular phone. The transmitting/receiving portion 12 transmit/receive a sound signal and a video signal as the cellular phone and also transmit/receive the data. The sound/video talk processing portion 13 executes the talking process through the phone conversation and the TV phone, the microphone 14 is used to input the sound, and the speaker 15 is used to output the sound. The display 16 is used to output the video, and the camera 17 is used to input the video. The key operating portion 18 consists of a ten key, function keys, etc., and key signals generated by the user's operation are input into the controlling portion 19. Here, there are power supply ON/OFF operation, calling operation, call answering operation, various operations regarding the key lending, and the like, for example, as the key operation.

The controlling portion 19 gives a control signal to the sound/video talk processing portion 13, the electronic key transmitting portion 21, and the disable command transmitting portion 22 in response to the key signal acquired from the key operating portion 18. For example, when the phone conversation is executed, the controlling portion 19 inputs a control signal into the electronic key transmitting portion 21, and the sound/video talk processing portion 13 to hold the phone conversation. Also, when the electronic key (key information) is transmitted, the controlling portion 19 inputs a control signal into the electronic key transmitting portion 21 to transmit the electronic key. Also, when a disable command to disable the already-transmitted electronic key is transmitted, the controlling portion 19 inputs a control signal into the disable command transmitting portion 22 for that purpose. The electronic key is transmitted to other communication terminal to lock/unlock an electronic lock 8 used as pairs of the electronic key. The electronic key is stored in the electronic key storing portion 23.

Following a start of the phone conversation or the multimedia phone (e.g., the TV phone), the session establishing portion 20 executes a predetermined sequence to establish the IMS session between the own communication terminal and other communication terminal as the opposing terminal. The electronic key transmitting portion 21 transmits the electronic key when the control signal is input from the controlling portion 19 to transmit the electronic key during the talking state (the phone conversation or the multimedia phone) after the session establishing portion 20 establishes the IMS session. In this case, the electronic key transmitting portion 21 reads the to-be-transmitted electronic key from the electronic key storing portion 23, and inputs it into the transmitting/receiving portion 12 to transmit its via the antenna 11. The disable command transmitting portion 22 transmits the disable command when the control signal to transmit the disable command is input from the controlling portion 19. The disable command is a command to disable the already-transmitted electronic key, and is transmitted toward a communication terminal 10-2 that receives the electronic key. In this case, the disable command can be composed of various signals known publicly to those skilled in the art.

As shown in FIG. 2, the communication terminal 10-2 is different from the above communication terminal 10-1 in that such terminal is equipped with an electronic key receiving portion (an electronic key receiving section) 21-2 instead of the disable command transmitting portion 22, and a disable command receiving portion 22-2 instead of the disable command transmitting portion 22. The electronic key receiving portion 21-2 receives the electronic key, and saves it in the electronic key storing portion 23. The disable command receiving portion 22-2 receives the disable command from the communication terminal 10-1 via the antenna 11 and the transmitting/receiving portion 12. When the disable command is sent to the electronic key storing portion 23, the electronic key storing portion 23 deletes the electronic key saved in the electronic key storing portion 23.

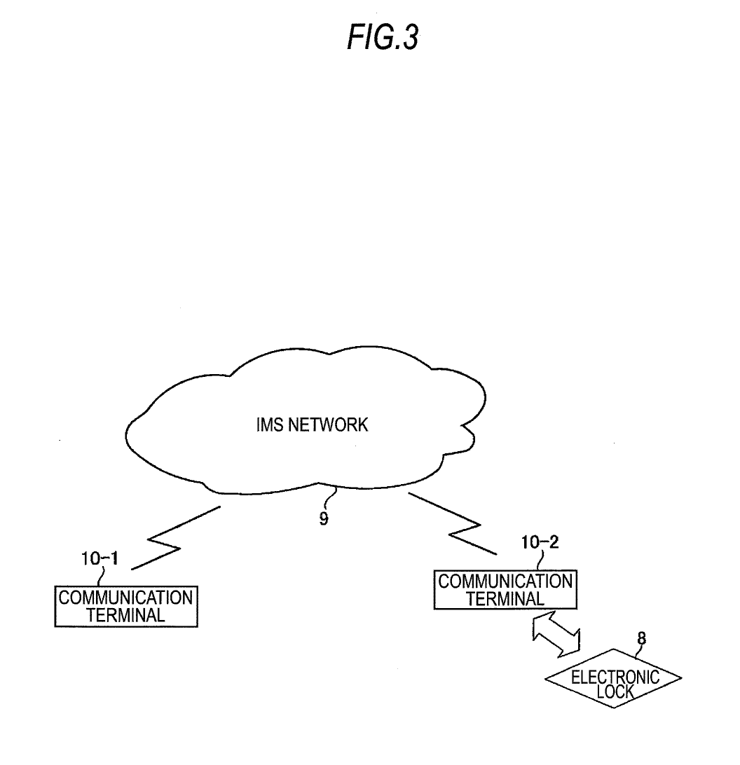

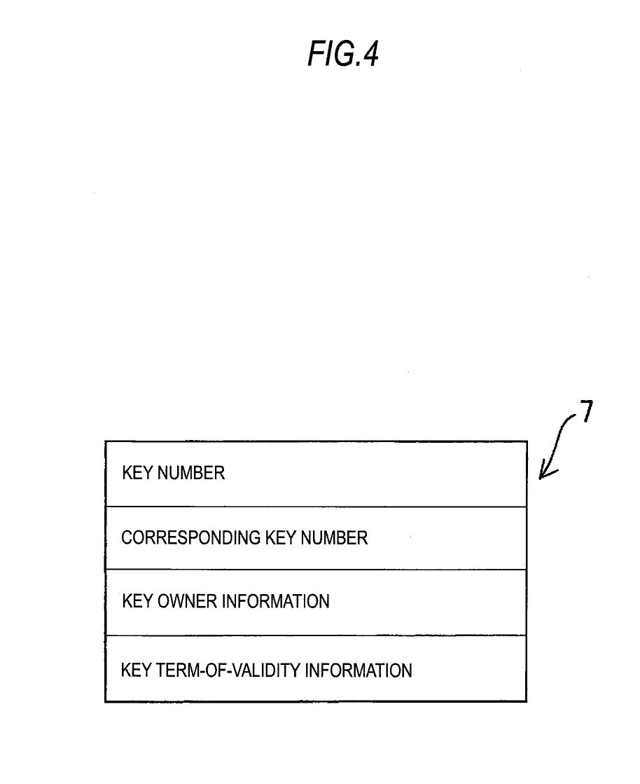

FIG. 3 is a conceptual view explaining the electronic key lending method according to the embodiment 1 of the present invention. In the electronic key lending method of the present embodiment, for example, an IMS network 9, the communication terminal 10-1, the communication terminal 10-2, an electronic key (see FIG. 4), and an electronic lock 8 are used. The communication terminal 10-1 is the communication terminal on the side that lends the electronic key, and the communication terminal 10-2 is the communication terminal on the side to which the electronic key is lent. That is, the communication terminal 10-1 lends the communication terminal 10-2 the electronic key 7, while the communication terminal 10-2 borrows the electronic key 7 from the communication terminal 10-1. The communication terminal 10-2 receives the electronic key 7 being transmitted from the communication terminal 10-1 via the IMS network 9.

FIG. 4 is a view explaining an example of the electronic key 7. The electronic key 7 is formed of electronic data, and has a data structure shown in FIG. 4. As shown in FIG. 4, the electronic key 7 contains the key number specifying the electronic lock, the lock number indicating the lock (corresponding to the electronic key) that is locked or unlocked by the electronic key, key owner information indicating a key owner, and information indicating the term of validity of the key within which the electronic key is available.

The electronic key that is usable in the present embodiment is not limited to the above key, and various publicly known electronic keys can be used. Details of the electronic key have already been explained in JP-A-2003-343133 and JP-A-2006-79402, for example.

When the user brings the electronic key 7 close to the electronic lock 8, for example, the electronic key 7 can open and/or close the electronic lock 8. In this case, various configurations known publicly to those skilled in the art can be applied as the electronic key 7 and the electronic lock 8. Also, various methods known publicly to those skilled in the art can be applied to the method of unlocking the electronic lock 8 by the electronic key 7 and the method of locking the electronic lock 8 by the electronic key 7. The communication terminal 10-2 disables the already-received electronic key 7 in response to the reception of the disable command transmitted from the communication terminal 10-1 as a trigger.

Here, the electronic key lending method of the present embodiment is not limited to that shown in FIG. 3. In the electronic key lending method of the present embodiment, for example, two IMS networks 9 or more, two communication terminals 10-1 or more, two communication terminals 10-2 or more, two electronic keys 7 or more, and two electronic locks 8 or more may be employed.

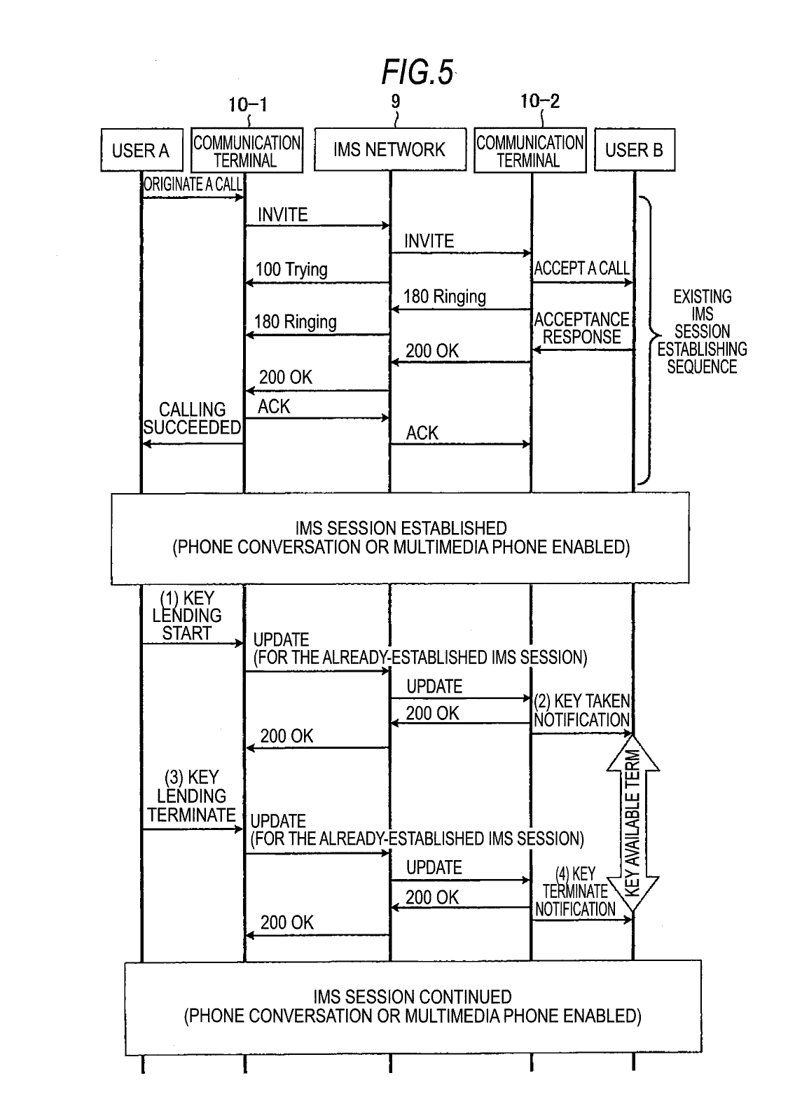

FIG. 5 is a sequence chart explaining the process applied when the IMS session is established and the user A lends the user B the key in the session. The user A is the user who lends out the electronic key 7, and the user B is the user to which the electronic key 7 is lent. The communication terminal 10-1 is the communication terminal that the user A uses, and the communication terminal 10-2 is the communication terminal that the user B uses. The IMS network 9 represents an entity on the network side constituting the IMS that is now standardized in 3GPP, and holds a function of routing a message among the communication terminals and a function of authenticating respective users. Such a case is illustrated herein that the user A possesses the electronic key 7 of the electronic lock 8 (see FIG. 3) and the user B opens the electronic lock 8 by using the electronic key 7.

In the sequence for establishing the IMS session shown in FIG. 5, an “INVITE” request is a message that means a request to the effect that the user intends to start or attend the IMS session. Both a “100 Trying” response and a “180 Ringing” response are a message informing that the request is accepted and is in process respectively. A “200 OK” response is a message informing that the request succeeded. An “ACK” request is a message indicating that it is checked that the final response (here, the “200 OK” response) in response to the “INVITE” request has been received.

As shown in FIG. 5, the user A and the user B exchange the message between the communication terminal 10-1 and the communication terminal 10-2 in compliance with the IMS session establishing procedures known publicly to those skilled in the art, and set up the IMS session. When the IMS session is established, the phone conversation or the multimedia phone (e.g. the TV phone) can be carried out. In this state, the user A operates the communication terminal 10-1 to start the key lending to the user B in the conversation. The communication terminal 10-1 attaches the electronic key 7 to a Body portion of an SIP UPDATE request, and sends it to the communication terminal 10-2. Here, the UPDATE request is a message indicating that update of the session information is requested in the IMS session being set up currently. The communication terminal 10-2, when receives the UPDATE request, sends the 200 OK response to the communication terminal 10-1. Also, the communication terminal 10-2 informs the user B that such terminal gets the electronic key 7. Accordingly, the user B can utilize the electronic key 7.

Then, the user A operates the communication terminal 10-1 at a timing at which the lending of the electronic key 7 should be terminated, while talking with the user B, and terminates the key lending. That is, the communication terminal 10-1 transmits a signal for disabling the electronic key 7 (an electronic key disabling signal) to the communication terminal 10-2. Concretely, the communication terminal 10-1 attaches a predetermined message to a Header portion or a Body portion of the SIP UPDATE request, and then sends it to the communication terminal 10-2, for example.

The communication terminal 10-2, when receives the UPDATE request, erases the electronic key 7 in the communication terminal 10-2. Then, the communication terminal 10-2 notifies the communication terminal 10-1 that the reception succeeded (transmits the 200 OK response), and notifies the user B of the key termination. Accordingly, the communication terminal 10-2 cannot use the electronic key 7.

In this way, the key lending between the user A and the user B can be implemented in real time. Here, an example of the user's operation in the case shown in FIG. 5 will be described in detail hereunder. Supposed that the electronic lock 8 of the home delivery box will be unlocked/locked.

The user A and the user B set up the IMS session by using the communication terminals 10-1, 10-2, and talks through the TV phone respectively.

When the user A starts to lend the user B the key during the TV phone, the user A selects “key lending start” from a menu displayed on a display of the communication terminal 10-1 (FIG. 1:(1)).

The communication terminal 10-2 informs the user B that the user A allows the key lending, by the display, the sound, or the like (FIG. 1:(2)). The user B opens the electronic lock 8 of the home delivery box by bringing the electronic key storing portion 23 of the communication terminal 10-2, which has received the electronic key 7, close to the electronic locks 8.

The user A checks that the user B has finished to use the electronic key 7, through the TV phone, or the like. Concretely, for example, when the user B finishes the placement of the delivery parcel in the home delivery box, the electronic lock 8 of the home delivery box is automatically locked.

The user A selects “key lending terminate” from a menu displayed on the display of the communication terminal 10-1 (FIG. 5:(3)).

The communication terminal 10-2 informs the user B that the user A terminates the key lending by the display, the sound, or the like (FIG. 5:(4)). Since the electronic key 7 in the communication terminal 10-2 has already disabled at a this point of time, the user B cannot no longer lock the electronic lock 8 by using the communication terminal 10-2.

As described above, according to the electronic key lending method of the present embodiment, the owner of the electronic key can lend the electronic key while communicating with the opposing terminal to which the electronic key is lent. Therefore, the high security in using the electronic key can be secured. Also, the operation becomes more simply for the user than the method in which the term of validity of the electronic key is set in advance before the key lending. Also, since the lent electronic key can be disables adequately according to the situation, the high security can be ensured. For example, in the situation that the delivery parcel, or the like is delivered when the user is away home, the user can lend temporarily the person of the delivery agent the electronic key of the home delivery box while talking through the TV phone to cause the person to store the parcel in the home delivery box, and can check the circumstances.

Also, no particular change is not needed on the network side because the IMS is utilized as the implementing unit. Also, the high security can be ensured because the existing user authentication of the IMS can be utilized. Also, there is no need to set up the communication for lending the key separately because the electronic key can be lend through the IMS session that has been set up to talk.

### Embodiment 2

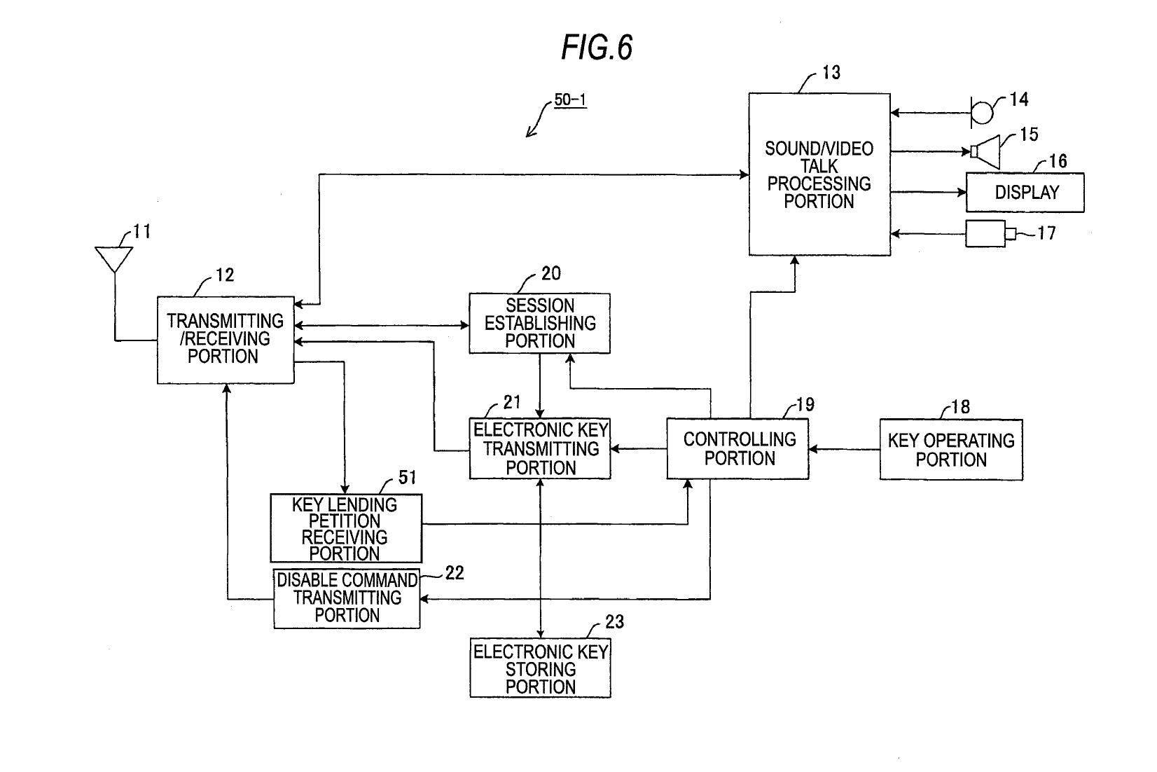

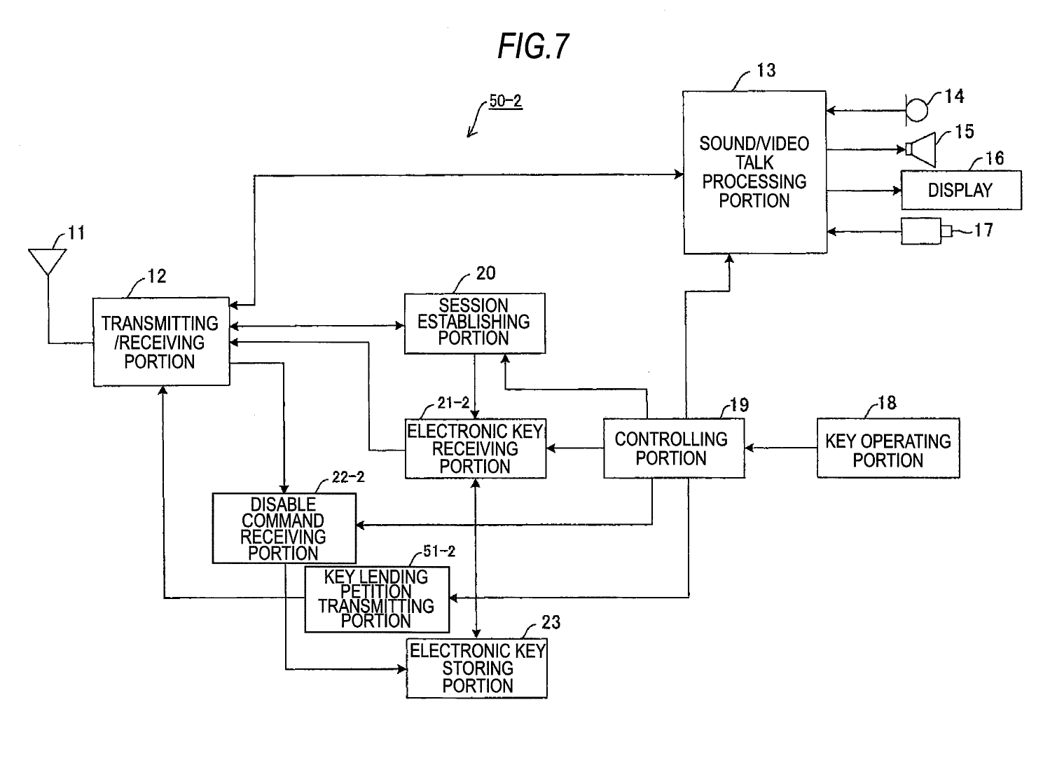

FIG. 6 is a block diagram showing a pertinent configuration of a communication terminal 50-1 (a communication terminal on the side which lends an electronic key) used in an electronic key lending method of an embodiment 2 of the present invention. FIG. 7 is a block diagram showing a pertinent configuration of another communication terminal 50-2 (a communication terminal on the side to which the electronic key is lent) used in the electronic key lending method of the embodiment 2 of the present invention. As shown in FIG. 6, a communication terminal 50-1 of the present embodiment is equipped with a key lending petition receiving portion 51, which receives a petition for lending of the electronic key (key information) from a communication terminal 50-2, in addition to the same configuration as the above communication terminal 10-1 shown in FIG. 1. When a petition for lending of the electronic key issued from the communication terminal 50-2 is received by the key lending petition receiving portion 51, the controlling portion 19 inputs a control signal into the sound/video talk processing portion 13 and causes the display 16 to display that the key lending request has been issued. When the user checked this display and executes an operation for allowing the key lending by the key operating portion 18, the controlling portion 19 inputs a control signal into the electronic key transmitting portion 21 to cause it to transmit the electronic key. The electronic key transmitting portion 21 reads the electronic key from the electronic key storing portion 23 in response to the input of this control signal, and transmits this electronic key.

As shown in FIG. 7, the communication terminal 50-2 is equipped with a key lending petition transmitting portion 51-2 (an electronic key request signal transmitting section) instead of the key lending petition receiving portion 51, in addition to the same configuration as the above communication terminal 50-1 shown in FIG. 6. When the user requests the key lending by using the key operating portion 18, the key lending petition transmitting portion 51-2 transmits the petition for key lending to the communication terminal 10-1 in response to the control signal from the controlling portion 19. Also, the communication terminal 50-2 is equipped with an electronic key receiving portion 21-2 instead of the electronic key transmitting portion 21 and a disable command receiving portion 22-2 instead of the disable command transmitting portion 22.

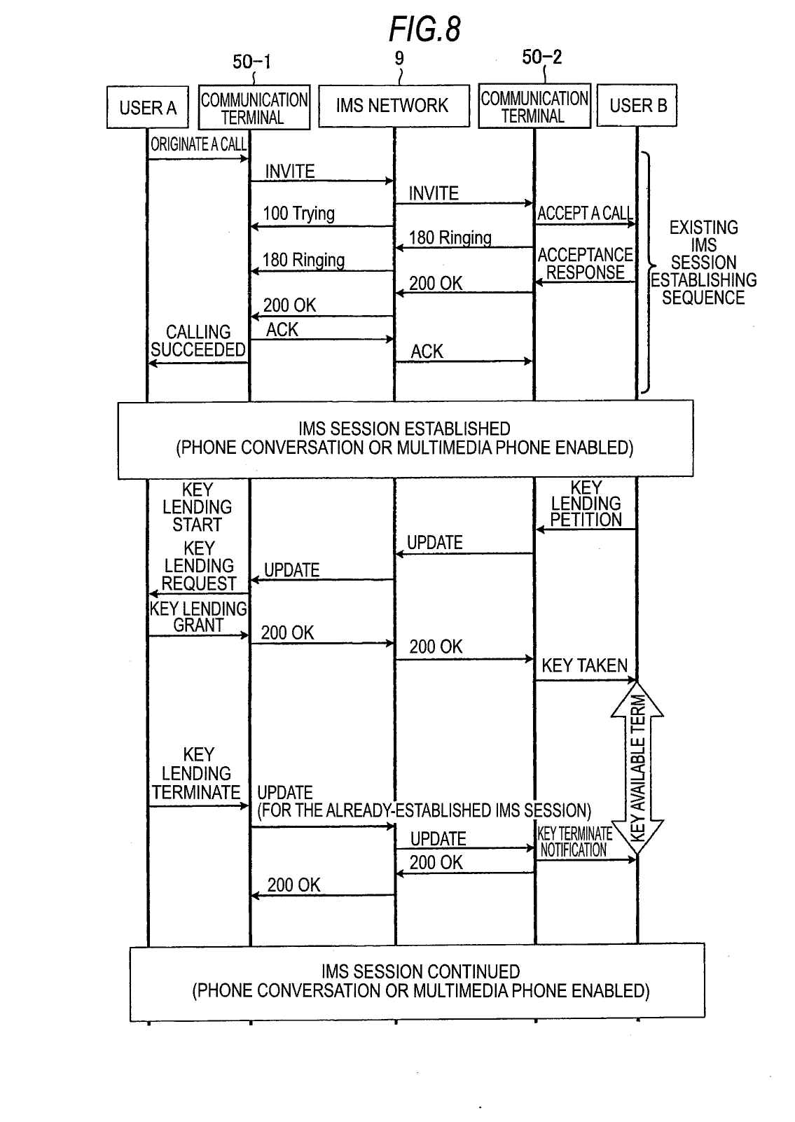

FIG. 8 is a sequence chart showing the process applied when the user B serves as a trigger and the user A who is a key owner lends the user B the key. In FIG. 8, when the user B executes an operation to send a petition for key lending, an UPDATE request indicating the petition for key lending is transmitted from the communication terminal 50-2 to the communication terminal 50-1. Then, a key lending request is transmitted to the user A. When the user A executes an operation to allow the key lending, the communication terminal 50-1 attaches the electronic key 7 to a Body portion of the 200 OK response that is transmitted to the communication terminal 50-2. The communication terminal 50-2 acquires the electronic key 7 by receiving the 200 OK response. Accordingly, the user B can use the electronic key 7.

Then, the user A operates the communication terminal 50-1 at a timing at which the lending of the electronic key 7 should be terminated, while talking with the user B, and terminate the key lending. That is, the communication terminal 50-1 transmits a signal for disabling the electronic key 7 (an electronic key disabling signal) to the communication terminal 50-2. Concretely, the communication terminal 50-1 attaches a predetermined message indicating that the electronic key 7 has been disabled, to a Header portion or a Body portion of the SIP UPDATE request, and then sends it to the communication terminal 50-2, for example. The communication terminal 50-2, when receives the UPDATE request, erases the electronic key 7 in the communication terminal 50-2. Then, the communication terminal 50-2 notifies the communication terminal 50-1 that the reception succeeded (transmits the 200 OK response), and notifies the user B of the key termination. Accordingly, the communication terminal 50-2 cannot use the electronic key 7.

In this manner, according to the communication terminal 50-1 of the present embodiment, the electronic key 7 is not transmitted until the petition for key lending is sent from the opposing terminal (the communication terminal 50-2) that lends the electronic key 7. Therefore, the unnecessary lending of the electronic key can be suppressed and the lending of the electronic key can be carried out effectively. The high security in using the electronic key can be secured. In the present embodiment, the electronic key 7 can also be of course disabled arbitrarily after the lending of the electronic key was done.

### Embodiment 3

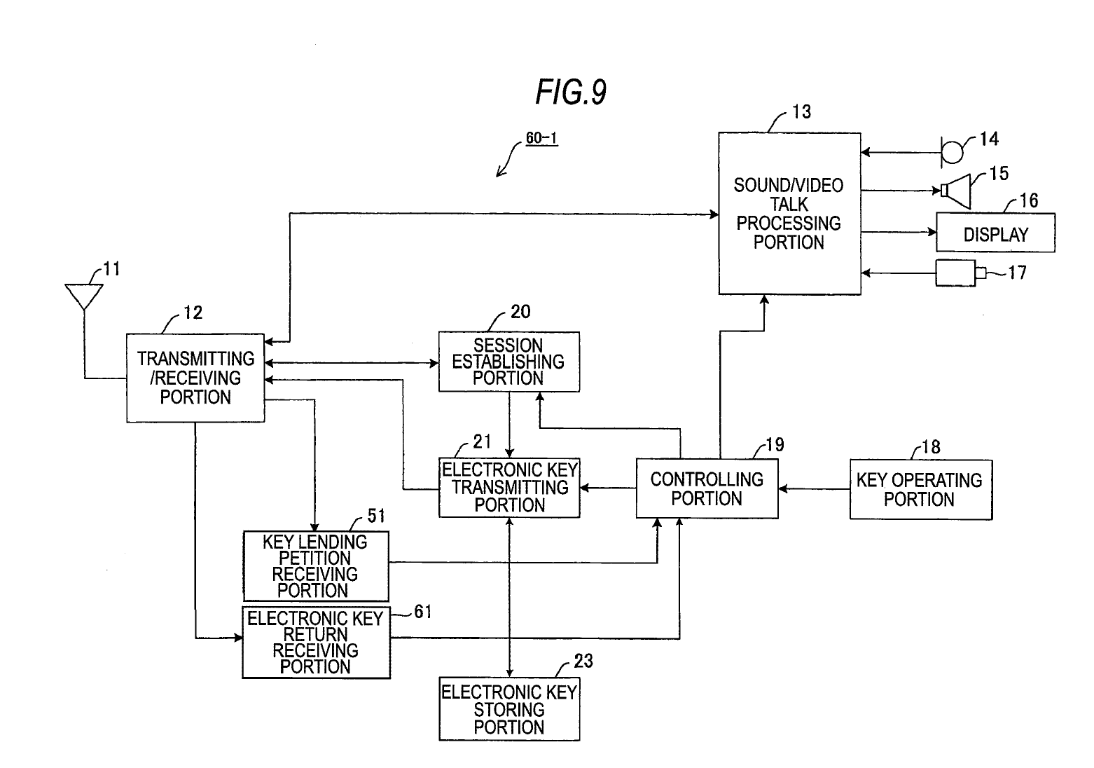

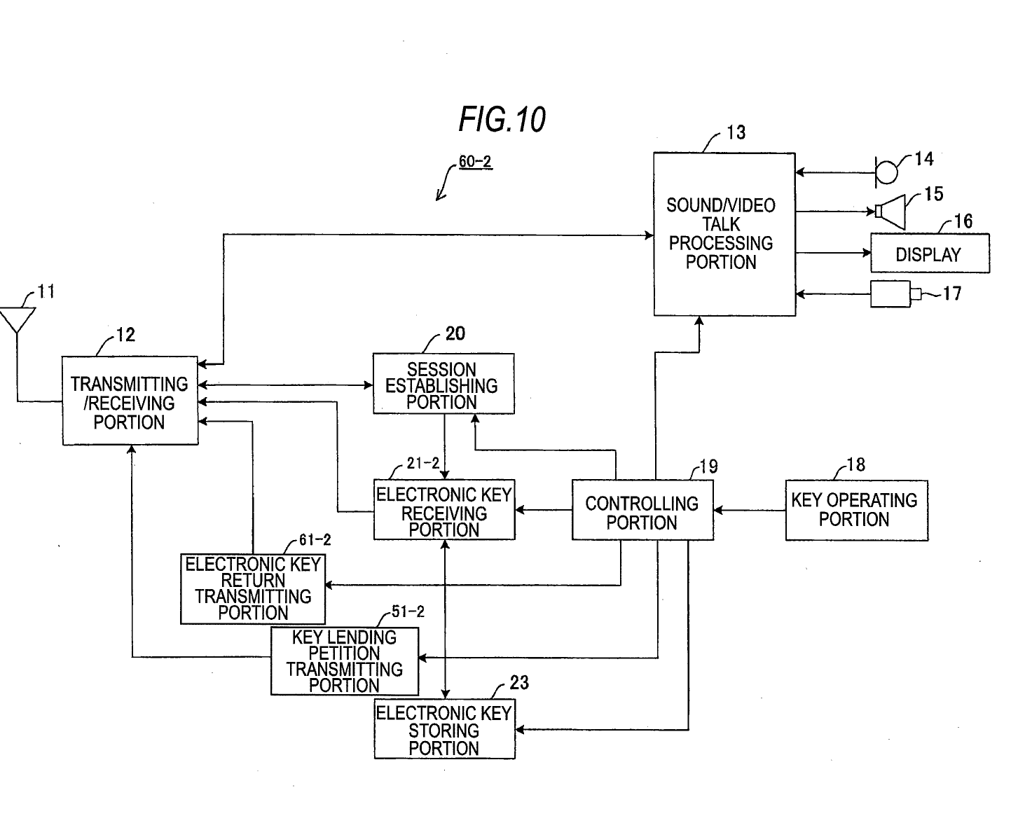

FIG. 9 is a block diagram showing a pertinent configuration of a communication terminal 60-1 (a communication terminal on the side which lends an electronic key) used in an electronic key lending method of an embodiment 3 of the present invention. FIG. 10 is a block diagram showing a pertinent configuration of another communication terminal 60-2 (a communication terminal on the side to which the electronic key is lent) used in the electronic key lending method of the embodiment 3 of the present invention. As shown in FIG. 9, the communication terminal 60-1 of the present embodiment has the almost same configuration as the above communication terminal 50-1 in FIG. 6, but is equipped with an electronic key return receiving portion (a disable information receiving section) 61 that receives the UPDATE request from the communication terminal 60-2 to return the electronic key, instead of the disable command transmitting portion 22. In the above Embodiment 2, the key lending is terminated on one communication terminal 60-1 side that possesses the electronic key 7. In contrast, in the present embodiment, the key lending can be terminated on the other communication terminal 60-2 side. In the present embodiment, when the electronic key return receiving portion 61 receives the UPDATE request from the communication terminal 60-2 to return the electronic key, the controlling portion 19 of the communication terminal 60-1 inputs a control signal to the sound/video talk processing portion 13 and causes the display 16 to display the fact that the key has been returned.

As shown in FIG. 10, the communication terminal 60-2 is equipped with an electronic key return transmitting portion (an electronic key disabling signal transmitting section) 61-2 instead of the disable command receiving portion 22-2, in addition to the almost same configuration as the above communication terminal 50-2 in FIG. 7. When the user issues the key return by operating the key operating portion 18, a control signal output from the controlling portion 19 disables the electronic key stored in the electronic key storing portion 23. Also, the electronic key return transmitting portion 61-2 transmits an electronic key return to the communication terminal 60-1 in response to the control signal from the controlling portion 19.

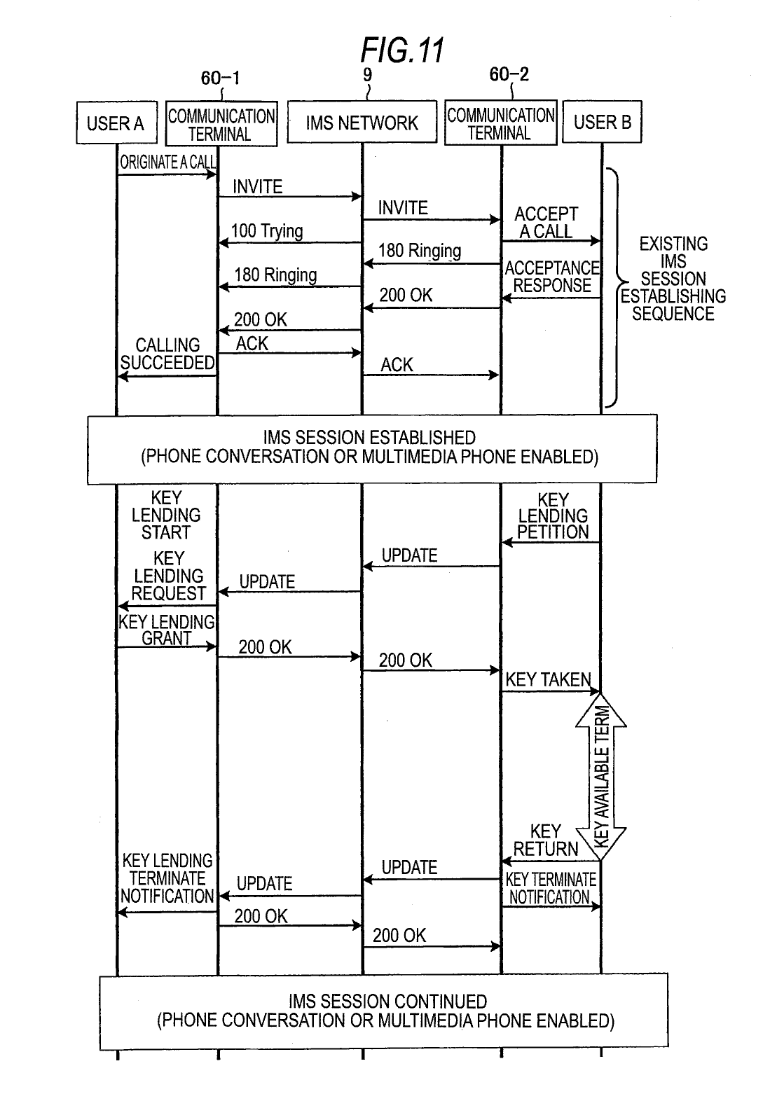

FIG. 11 is a sequence chart showing the process applied when the user B terminates the lending of the key. In FIG. 11, after the user B got the electronic key 7, such user B operates the communication terminal 60-2 at a timing at which the lending of the electronic key 7 should be terminated while talking with the user A, and returns the electronic key. The communication terminal 60-2 erases the electronic key (key information) in the communication terminal 60-2, and attaches a message indicating that the key has been returned to a Header or Body portion of the SIP UPDATE request and transmits the request to the communication terminal 60-1. The communication terminal 60-1, when receives the UPDATE request, notifies the user A that the electronic key has been returned. Also, the communication terminal 60-1 notifies the communication terminal 60-2 that the key return has been accepted (200 OK transmission). The communication terminal 60-2, when accepted the key return, notifies the user B that the key is terminated. Accordingly, it is impossible for the communication terminal 60-2 to use the electronic key 7. When the above process is executed by the operation made by the user B, the communication terminal 60-2 may not notify the user B of the key termination at a time of receiving the 200 OK because the key termination is apparent to the user B.

In this manner, according to the communication terminal 60-1 of the present embodiment, the communication terminal 60-2 that lent out the electronic key 7 can check the return of the electronic key 7 for itself, and the electronic key 7 is erased in the communication terminal 60-2 from which the electronic key 7 is lent. Therefore, the high security in using the electronic key can be ensured.

### Embodiment 4

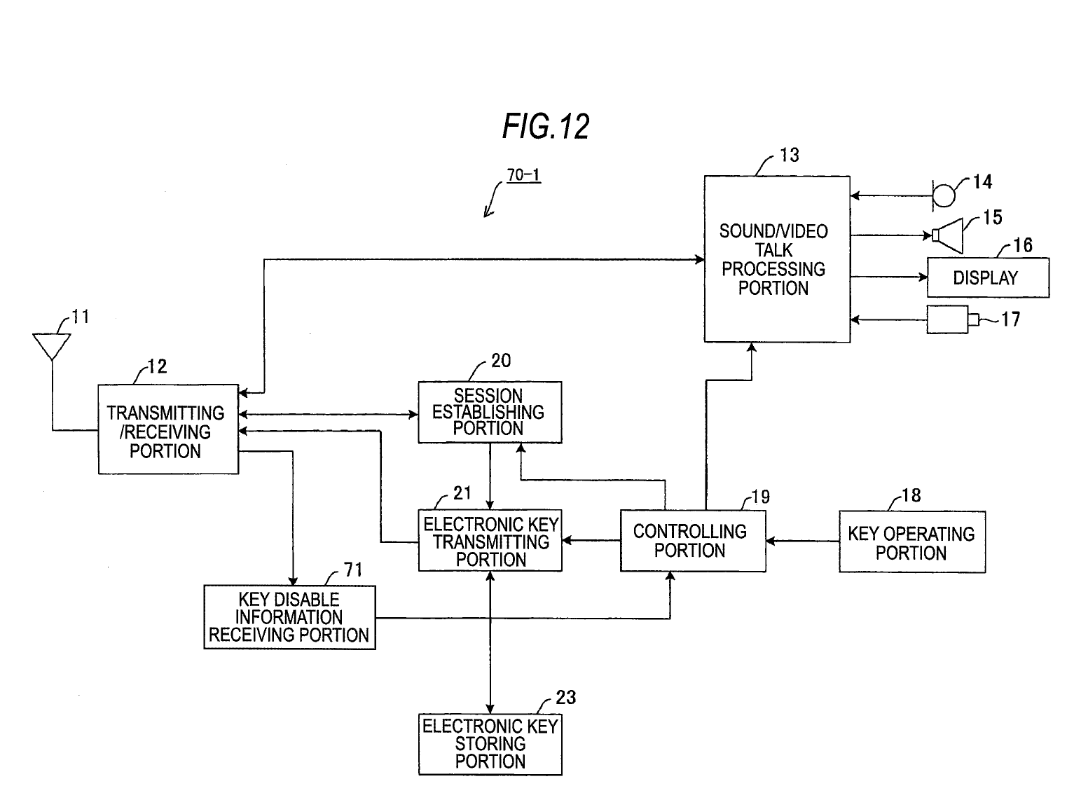

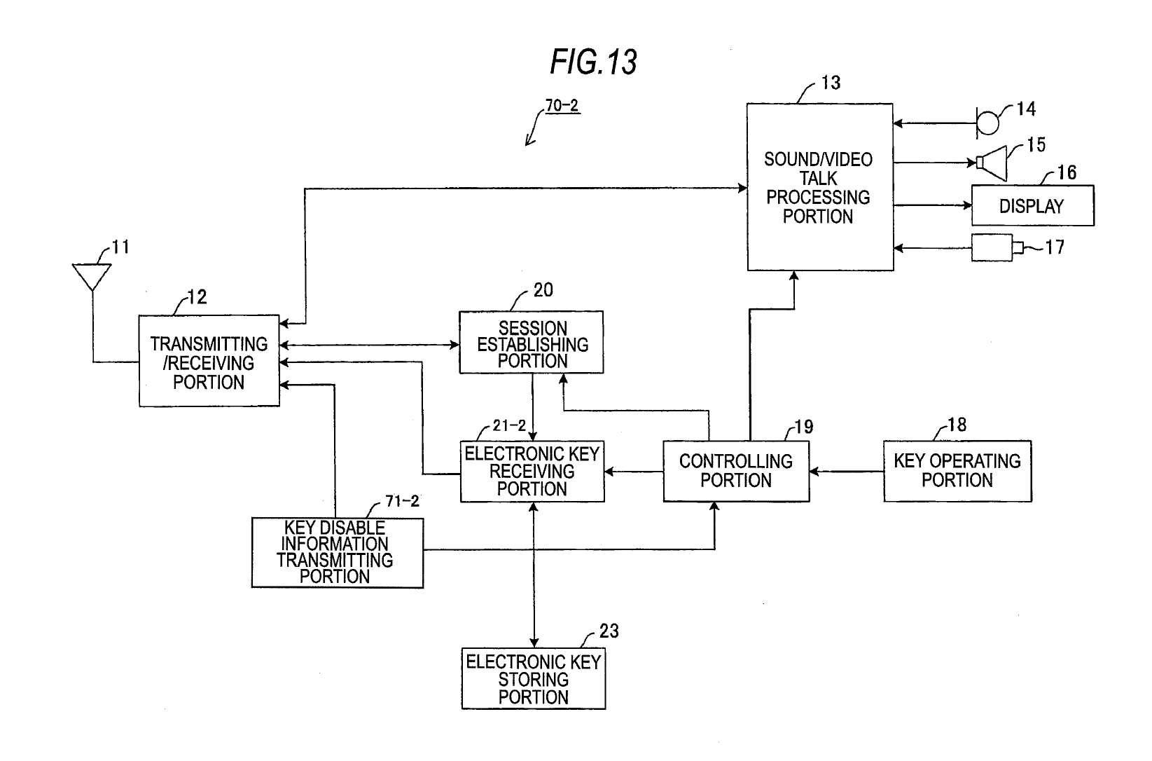

FIG. 12 is a block diagram showing a pertinent configuration of a communication terminal 70-1 (a communication terminal on the side which lends an electronic key) used in an electronic key lending method of an embodiment 4 of the present invention. FIG. 13 is a block diagram showing a pertinent configuration of another communication terminal 70-2 (a communication terminal on the side to which the electronic key is lent) used in the electronic key lending method of the embodiment 4 of the present invention. As shown in FIG. 12, the communication terminal 70-1 of the present embodiment has the almost same configuration as the above communication terminal 10-1 in FIG. 1, but is equipped with a key disable information receiving portion (a disable information receiving section) 71 for receiving a key disable information from the communication terminal 70-2, instead of the disable command transmitting portion 22. When the key disable information from other communication terminal 70-2 is received by the key disable information receiving portion 71, the controlling portion 19 of the communication terminal 70-1 of the present embodiment inputs a control signal into the sound/video talk processing portion 13, and causes the display 16 to display the fact that the electronic key (key information) is disabled. Here, concretely the “key disable information” is the information that notifies the communication terminal 70-1 that the electronic key has been disabled in the communication terminal 70-2.

As shown in FIG. 13, the communication terminal 70-2 is equipped with a key disable information transmitting portion 71-2 instead of the disable command receiving portion 22-2, in addition to the almost same configuration as the above communication terminal 10-2 in FIG. 2. When the user releases the IMS session by using the key operating portion 18, a control signal from the controlling portion 19 disables the electronic key stored in the electronic key storing portion 23. Also, the key disable information transmitting portion 71-2 transmits key disable signal to the communication terminal 70-1 in response to the control signal from the controlling portion 19.

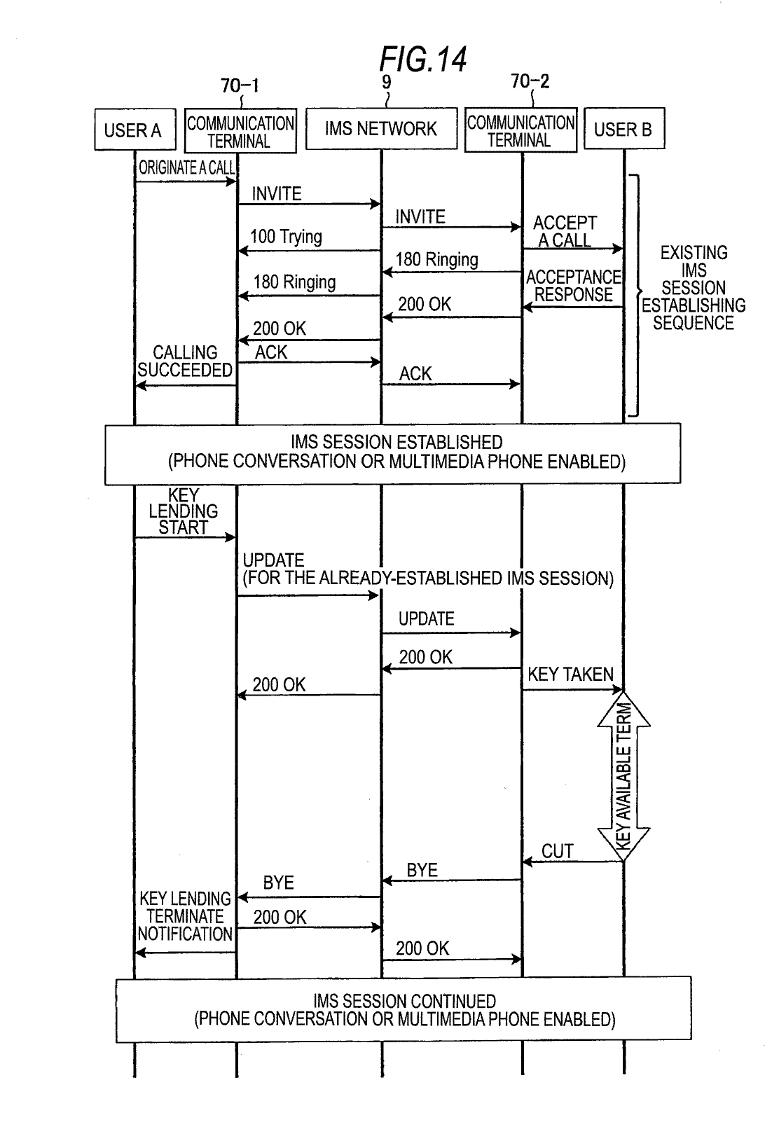

FIG. 14 is a sequence chart showing the process applied when the IMS session is terminated suddenly while the user B is using the electronic key. In FIG. 14, when the communication terminal 70-2 acquired the electronic key, this terminal notifies the user B of the key acquisition. Therefore, the user B can use the electronic key 7. Then, when the user B cuts the IMS session by operating the communication terminal 70-2 or the IMS session is cut for some cause or other while the user A and the user B are talking with each other on the phone, the communication terminal 70-2 transmits a BYE request informing that the IMS session being set up is released to the communication terminal 70-1. When the communication terminal 70-1 received the BYE request, this terminal notifies the user A that the IMS session is cut off and the key lending is terminated. The communication terminal 70-2 erases the electronic key 7 that has been acquired in this session at a point of time when the communication terminal 70-2 detected the release of the IMS session. In this case, since the electronic key 7 is lent within the IMS session, the electronic key 7 cannot be used at a point of time when the IMS session is releases (cut).

In this manner, according to the communication terminal 70-1 of the present embodiment, this communication terminal 70-1 can check the fact that the electronic key 7 cannot be used in the communication terminal 70-2, to which the communication terminal 70-1 has lent the electronic key 7, at a point of time when the IMS session is cut. Therefore, the high security in using the electronic key can be ensured.

### Embodiment 5

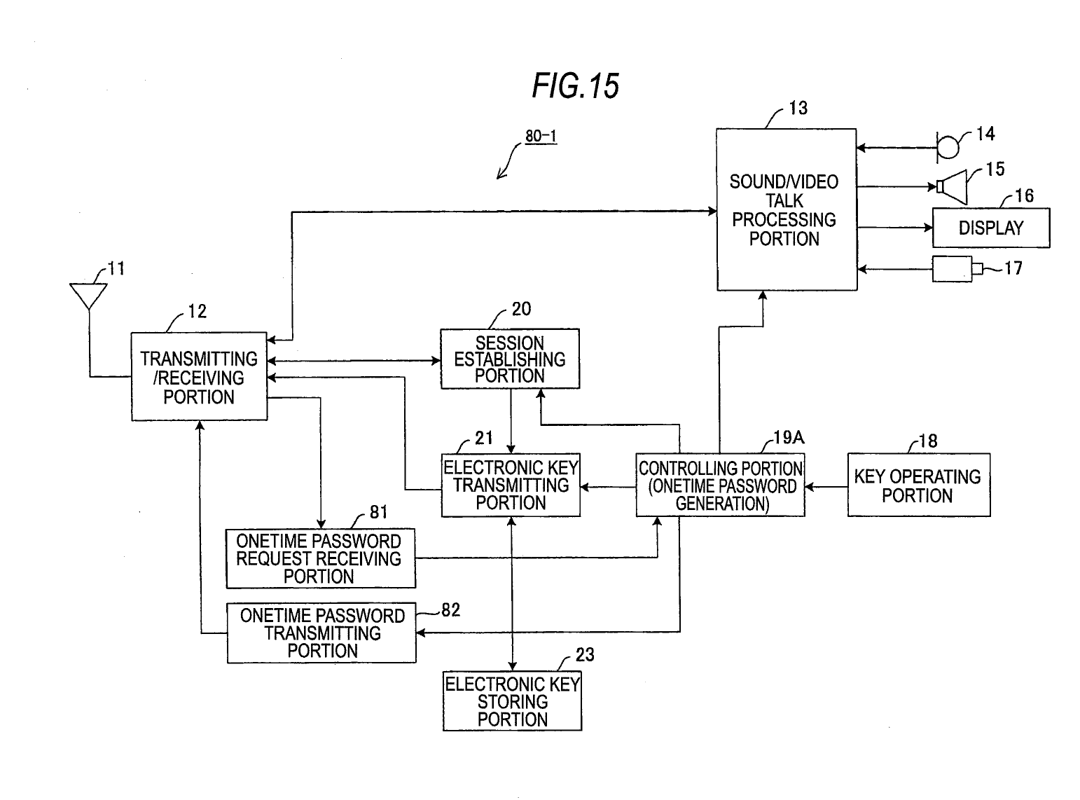

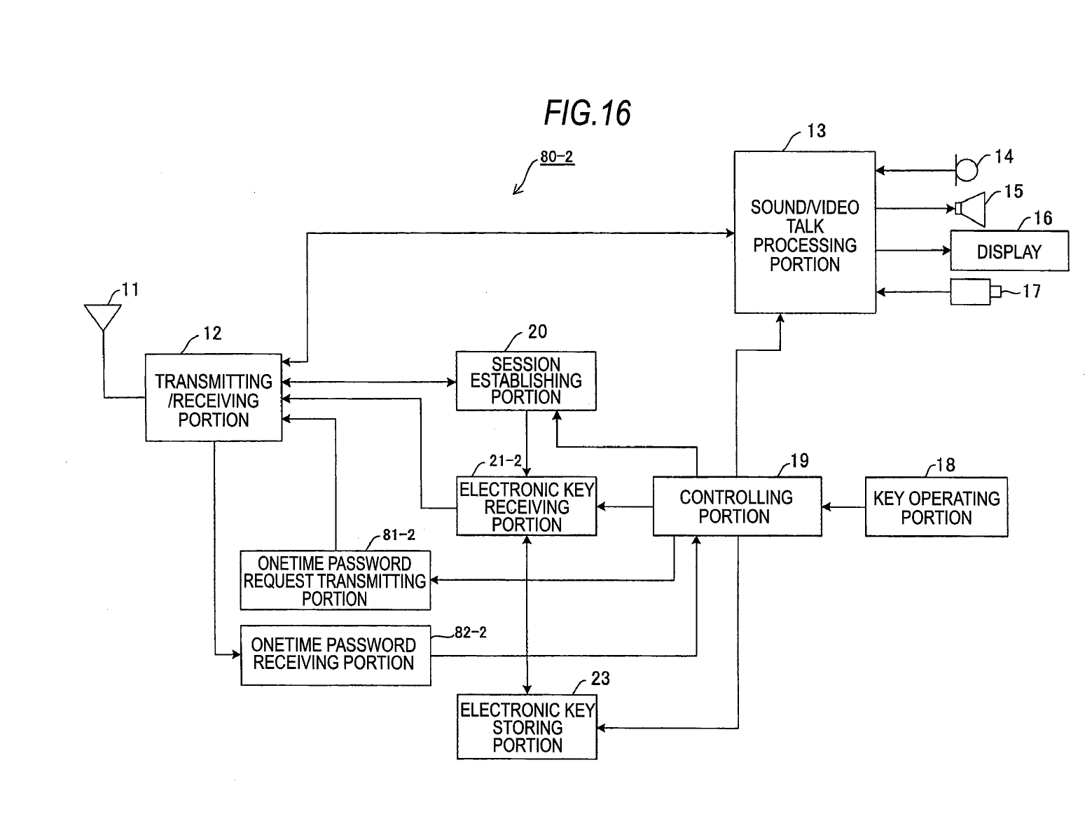

An embodiment 5 has a feature in an aspect that the onetime password is used in addition to the electronic key to open the electronic lock. Here, the “onetime password” is a password that can be used only once, and is disabled after it is used once. FIG. 15 is a block diagram showing a pertinent configuration of a communication terminal 80-1 (a communication terminal on the side which lends an electronic key) used in an electronic key lending method of an embodiment 5 of the present invention. FIG. 16 is a block diagram showing a pertinent configuration of another communication terminal 80-2 (a communication terminal on the side to which the electronic key is lent) used in the electronic key lending method of the embodiment 5 of the present invention. As shown in FIG. 15, the communication terminal 80-1 of the present embodiment has the almost same configuration as that in FIG. 1 mentioned above, but is equipped with a onetime password request receiving portion 81 for receiving the onetime password request from the communication terminal 80-2 and a onetime password transmitting portion 82 for transmitting the generated onetime password, instead of the disable command transmitting portion 22. A controlling portion 19A has a function of generating the onetime password, and generates the onetime password transmitted from the onetime password transmitting portion 82. That is, when the onetime password request receiving portion 81 received the onetime password request from the communication terminal 80-2, the controlling portion 19A generates the onetime password and inputs it into the onetime password transmitting portion 82.

As shown in FIG. 16, the communication terminal 80-2 is equipped with a onetime password request transmitting portion 81-2 and a onetime password receiving portion 82-2 instead of the disable command receiving portion 22-2, in addition of the almost same configuration as the above communication terminal 10-2 in FIG. 2.

The onetime password request is made from the electronic lock 8 when the user brings the communication terminal 80-2 to which the electronic key 7 is lent to the electronic lock 8. The communication terminal 80-2 to which the electronic key 7 is lent receives this onetime password request at the electronic key storing portion 23, and then this onetime password request is transmitted from the onetime password request transmitting portion 81-2 to the communication terminal 80-1. The onetime password is generated in the communication terminal 80-1 and then the electronic key 7 is transmitted to the communication terminal 80-2. Then, the onetime password receiving portion 82-2 of the communication terminal 80-2 to which the electronic key 7 is lent receives the onetime password, and the controlling portion 19 notifies the electronic key storing portion 23 of the onetime password. The electronic key storing portion 23 can open the electronic lock 8 by using the acquired onetime password. Since the procedures from the request of the onetime password made by the electronic lock 8 to the reception of the onetime password by the communication terminal 80-2 is completed in a short time, the user B can unlock the electronic lock 8 without knowing that the process regarding the onetime password occurs. In the present embodiment, even when the electronic key is not erased on the communication terminal side to which the electronic key 7 was lent, the high security in using the electronic key can be ensured because of the employment of the onetime password.

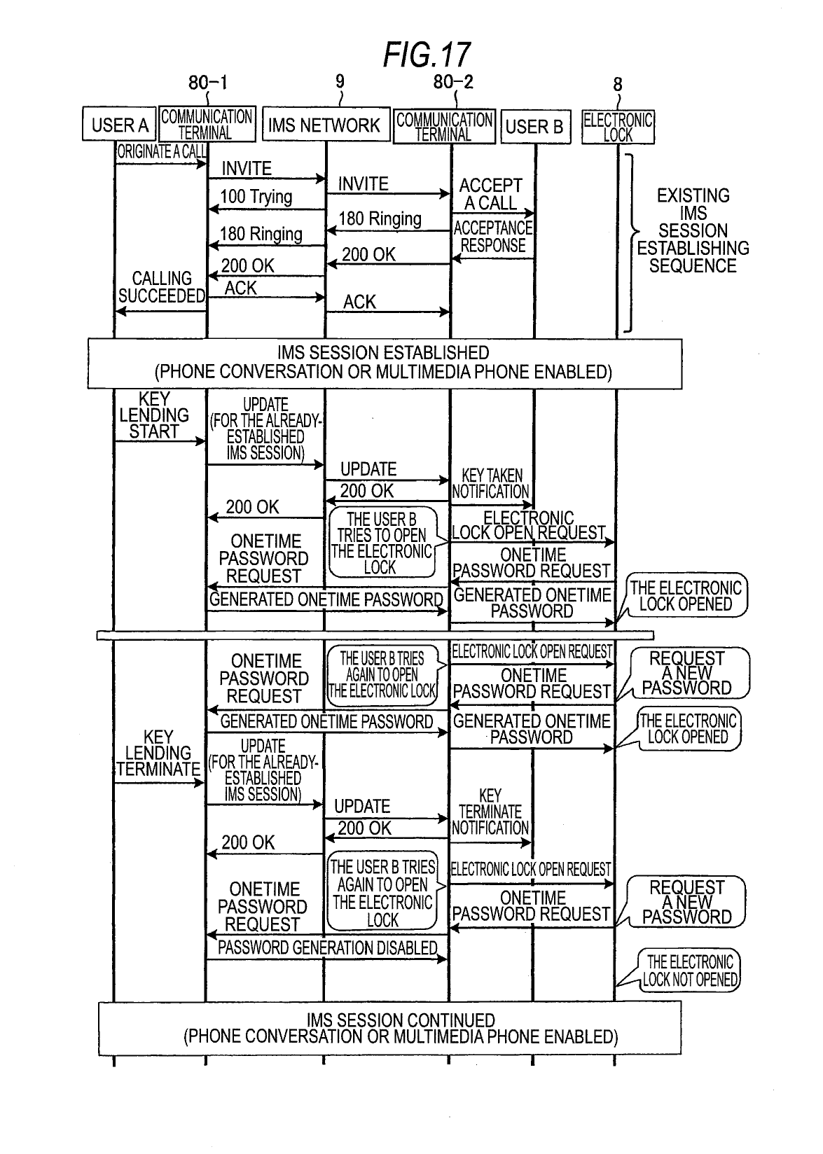

FIG. 17 is a sequence chart showing the process between the communication terminals in lending the key using the onetime password. As shown in FIG. 17, after the IMS session is established, the electronic key is transmitted from the communication terminal 80-1 to the communication terminal 80-2 in response to the operation made by the user A. After the communication terminal 80-2 received the electronic key, the user B brings the communication terminal 80-2 close to the electronic lock 8 to open the electronic lock 8, and then the onetime password request is issued from the electronic lock 8. When the communication terminal 80-2 receives the onetime password from the electronic lock 8, it transfers the onetime password to the communication terminal 80-1. The communication terminal 80-1, when acquired the onetime password request issued from the electronic lock 8, generates the onetime password and then transmits it to the communication terminal 80-2. The communication terminal 80-2 gives the acquired onetime password to the electronic lock 8 when the user puts the communication terminal 80-2 close to the electronic lock 8. Accordingly, the user can unlock the electronic lock 8.

The onetime password is generated in the communication terminal 80-1 in response to the onetime password request issued from the electronic lock 8 every time when the user B (the communication terminal 80-2) tries to open the electronic lock 8. In a situation that the electronic key information in the communication terminal 80-2 is not disabled for some reason after the communication terminal 80-1 notifies the communication terminal 80-2 that the lending of the electronic key has been terminated, the onetime password is not generated even though the user B tries again to open the electronic lock 8. Therefore, the user B cannot open the electronic lock 8 by the communication terminal 80-2.

In this case, as the protocol used upon receiving the onetime password, MSRP (Message Session Relay Protocol) whose specifications are being defined in RTP (Real time Transport Protocol), RTCP (RTP Control Protocol), RTSP (Real Time Streaming Protocol), and IETF (Internet Engineering Task Force) used in the phone conversation can be used in addition to the SIP. As a mechanism of the onetime password that is transmitted/received between the electronic lock 8 and the communication terminal 80-1, the method whose mechanism used to generate the password cannot be analyzed in the communication terminal 80-2, for example, Digest authentication, or the like may be employed.

In this manner, according to the communication terminal 80-1 of the present embodiment, the user cannot open the electronic lock 8 unless such user use the onetime password as well as the electronic key 7. Therefore, even when the key information could not appropriately deleted due to ill will or any trouble from the communication terminal 80-2 to which the electronic key was lent, abuse and misuse of the electronic key can be prevented. As a result, the high security in using the electronic key can be ensured in using the electronic key between the communication terminals.

The present invention is explained in detail with reference to the particular embodiments. But it is apparent for those skilled in the art that various variations and modifications can be applied without departing from a spirit and a scope of the present invention.

### INDUSTRIAL APPLICABILITY

The present invention can be applied widely to various communication terminals to which the IMS can be applied.

1. A method of lending out an electronic key which unlocks or locks an electronic lock from a first communication terminal, comprising:
an electronic key transmitting step of transmitting the electronic key from the first communication terminal by using the IMS session to a second communication terminal while an IMS session is established between the first communication terminal and the second communication terminal and a phone conversation or a multimedia communication is executed between the first communication terminal and the second communication terminal by using the IMS session.

2. The method of lending out the electronic key according to claim 1, wherein the IMS session is a single session; and
wherein the electronic key transmitting step does not establish a session other than the IMS session.

3. The method of lending out the electronic key according to claim 1, wherein, when the first communication terminal receives a first signal, the electronic key is transmitted selectively from the first terminal to the second terminal in the electronic key transmitting step.

4. The method of lending out the electronic key according to claim 1, further comprising:
an electronic key enabling step of opening or shutting the electronic lock selectively by the electronic key when the electronic lock receives a second signal after the electronic key transmitting step.

5. The method of lending out the electronic key according to claim 1, further comprising:
an electronic key disabling step of disabling the electronic key when the second communication terminal receives a third signal after the electronic key transmitting step.

6. A communication terminal, comprising:
an IMS session establishing section which establishes an IMS session between the communication terminal and other communication terminal;
a communication section which establishes a communication with the other communication terminal by using the IMS session establishing section; and
an electronic key transmitting section which transmits an electronic key to the other communication terminal to open or shut an electronic lock while the IMS session is established and a phone conversation or a multimedia communication is executed between the communication terminal and the other communication terminal by using the IMS session.

7. The communication terminal according to claim 6, wherein the IMS session is a single session; and
wherein the electronic key transmitting section does not use a session other than the IMS session.

8. The communication terminal according to claim 6, wherein, when the communication terminal receives a predetermined signal from the other communication terminal, the electronic key transmitting section transmits the electronic key selectively.

9. The communication terminal according to claim 6, further comprising:
an electronic key enabling signal transmitting section which transmits an electronic key enabling signal to open or shut the electronic lock by the electronic key.

10. The communication terminal according to claim 6, further comprising:
an electronic key disabling signal transmitting section which transmits an electronic key disabling signal to disable the electronic key.

11. A communication terminal, comprising:
an IMS session establishing section which establishes an IMS session between the communication terminal and other communication terminal;
a communication section which establishes a communication with the other communication terminal by using the IMS session establishing section; and
an electronic key receiving section which receives an electronic key to the other communication terminal to open or shut an electronic lock while the IMS session is established and a phone conversation or a multimedia communication is executed between the communication terminal and the other communication terminal by using the IMS session.

12. The communication terminal according to claim 11, wherein the IMS session is a single session; and
wherein the electronic key receiving section does not use a session other than the IMS session.

13. The communication terminal according to claim 11, further comprising:
an electronic key request signal transmitting section which transmits a signal indicating an electronic key lending request to the other communication terminal.

14. The communication terminal according to claim 11, further comprising:
an electronic key enabling signal receiving section which receives an electronic key enabling signal to open or shut the electronic lock by the electronic key.

15. The communication terminal according to claim 11, further comprising:
an electronic key disabling signal receiving section which receives an electronic key disabling signal to disable the electronic key.
